(19) United States
(12) Patent Application Publication
(10) Pub. No.: US 2005/0200111 A1
(43) Pub. Date: Sep. 15, 2005

(54) Multi piece bearing for telescoping steering column assembly

(76) Inventors: William D. Cymbal, Freeland, MI (US); Richard K. Riefe, Saginaw, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/797,959

(22) Filed: Mar. 11, 2004

(51) Int. Cl. B62D 1/16

(52) U.S. Cl. 280/775

(57) ABSTRACT

A telescoping steering column assembly (10) includes upper (12) and lower (20) jackets having inner (14,22) and outer (16,24) surfaces and telescoping ends (28,30), (32,34), respectively, and two sleeves (40,50) disposed therebetween and having an annular cavity (46,56) defined within each of the sleeves (40,50) to hold bearings (36), (60) therewithin. One bearing (60) is connected to the upper jacket (12) and the other bearing (36) is connected to the lower jacket (20). A method of making the assembly (10) includes the steps of disposing the lower jacket (20) within the upper jacket (12) followed by disposing the sleeves (40,50) therebetween and injecting a plastic material (P) therethrough to form bearings (36,60). The plastic material (P) is extracted from one of the holes (18,66) in each of the jackets (12,20) to provide a sliding engagement between one of the bearing (60) and the lower jacket (20) and another bearing (36) and the upper jacket (12).

### BACKGROUND OF THE INVENTION

1. Field of the Invention

The subject invention relates to a vehicle steering column of the kind having jackets of the column engaged one within the other in a telescoping fashion to adjust a height position of a steering wheel connected to the vehicle steering column to accommodate the position of a driver.

2. Description of the Prior Art

Generally, a variety of tilting and telescoping steering column arrangements have been developed and are used today in the field of automotive industry. A telescoping steering column assembly typically uses two jackets, wherein one jacket is fixed to a frame of a vehicle body, and the other jacket is adapted to be translated with respect to the jacket fixed to the frame, thereby providing relative longitudinal movement between the two jackets with respect to one another. These jackets, engaged one within another in a telescoping fashion, allow the driver to push or pull the steering wheel to a desired position and then to lock the telescoping column. Three fundamental conditions are required by the telescoping adjustment: the telescoping steering column must have a low adjustment force, the jackets must lock securely, and the stiffness of the telescoping steering column must not be degraded.

Various configurations and designs are available in the prior art for linear guide mechanism for adjusting telescoping steering column assemblies and have been disclosed in U.S. Pat. No. 3,703,105 to Milton et al., U.S. Pat. No. 4,667,530 to Mettler et al., U.S. Pat. No. 5,306,032 to Hoblingre et al., U.S. Pat. No. 5,086,661 to Hancock, U.S. Pat. No. 5,590,565 to Palfenier et al., U.S. Pat. No. 5,722,300 to Burkhard et al., U.S. Pat. No. 6,354,626 to Cartwright, U.S. Pat. No. 6,371,519 to Jurik et al., U.S. Pat. No. 6,389,923 to Barton et al., and U.S. Pat. No. 6,473,968 to Mastrofrancesco et al. In addition, various configurations and designs for linear guide mechanism for adjusting telescoping steering column assemblies have been disclosed in United Kingdom Patent No. GB 2184213 to Arnold, French Patent No. 2561605 to Haldric, and PCT Patent Application No. WO 02/064989 to Zemickel et al. Several prior art designs include a sleeve bushing disposed between the jackets disposed one within the other in the telescoping fashion wherein the sleeve bushing travels with the upper jacket when the steering column telescoped inwardly and outwardly in different operational modes.

There remains a constant need to improve the bearing support of the telescoping jackets in a steering column assembly.

### BRIEF SUMMARY OF INVENTION

A telescoping steering column assembly of the present invention includes an upper jacket having inner and outer surfaces with a hole extending between said surfaces thereof and a lower jacket having inner and outer surfaces with a hole extending between the surfaces thereof. The upper and lower jackets have telescoping ends disposed in overlapping telescoping relationship with one another. A bearing of plastic material is disposed annularly about the outer surface of the lower jacket and engages the inner surface of the upper jacket. The bearing is disposed in a sliding engagement over the hole in one of said jackets and includes a projection extending into the hole in the other of the jackets.

The present invention includes a method of making a telescoping steering column assembly comprising the steps of disposing a lower jacket having a hole extending between inner and outer surfaces and a telescoping end in telescoping relationship within an upper jacket having a hole extending between inner and outer surfaces and a telescoping end. The next step of the method includes injecting a plastic material between the upper and lower jackets and into the respective holes in the jackets, followed by the step of removing the plastic material from the hole in only one of the jackets.

An advantage of the present invention is to provide a design for adjusting the relative longitudinal position between two jackets of a steering column that improves bearing strength of the telescoping steering column assembly.

Another advantage of the present invention is to provide a linear bushing that may be used on any telescoping steering column of the same diameter and with different overlap length.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an exploded perspective view of a telescoping steering column assembly of the present invention;

FIG. 2 is a fragmentary cross sectional view of a lower jacket disposed within an upper jacket and sleeves spaced from one the other and disposed annularly about the lower jacket and engaging the upper jacket, wherein each sleeve defines an annular cavity open to the jackets;

FIG. 3 is a fragmentary another cross sectional view of the lower jacket disposed within the upper jackets, shown in FIG. 2, having bearings disposed in the annular cavity of each sleeve;

FIG. 4 is a cross sectional view taken along line 4-4 of FIG. 3;

FIG. 5 is a cross sectional view taken along line 5-5 of FIG. 3;

FIG. 6 shows a step of disposing the lower jacket in a telescoping relationship within the upper jacket of a method of the present invention;

FIG. 7 shows a step of disposing the sleeves annularly about the lower jacket and within the upper jacket;

FIG. 8 shows a step of inserting a bar into the lower jacket to prevent a plastic material from penetrating into the lower jacket;

FIG. 9 shows a step of injecting the plastic material through the jackets and sleeved disposed therebetween to form bearings disposed within the sleeves, respectively;

FIG. 10 shows a step of removing the plastic material from holes of the upper jacket; and

FIG. 11 shows a step of removing the plastic material from holes of the lower jacket.

### DETAILED DESCRIPTION OF THE INVENTION

Referring to the Figures wherein like numerals indicate like or corresponding parts throughout the several views, a telescoping steering column assembly of the present invention is generally shown at 10.

The telescoping steering column assembly 10 includes an upper jacket, generally indicated at 12, having inner 14 and outer 16 surfaces with a hole 18 extending between the surfaces 14, 16 thereof and a lower jacket, generally indicated at 20, having inner 22 and outer 24 surfaces with a hole 26 extending between the surfaces 22, 24 thereof. The upper 12 and lower 20 jackets have telescoping ends 28, 30, 32, 34, respectively, disposed in overlapping telescoping relationship with one another. A bearing 36 of plastic material P of the assembly 10 is disposed annularly about the outer surface 24 of the lower jacket 20 and the inner surface 14 of the upper jacket 12. The bearing 36 is disposed in a sliding engagement over the hole 18 in one of the jackets 12 and includes a projection 38 extending into the hole 26 in the other of the jackets 20.

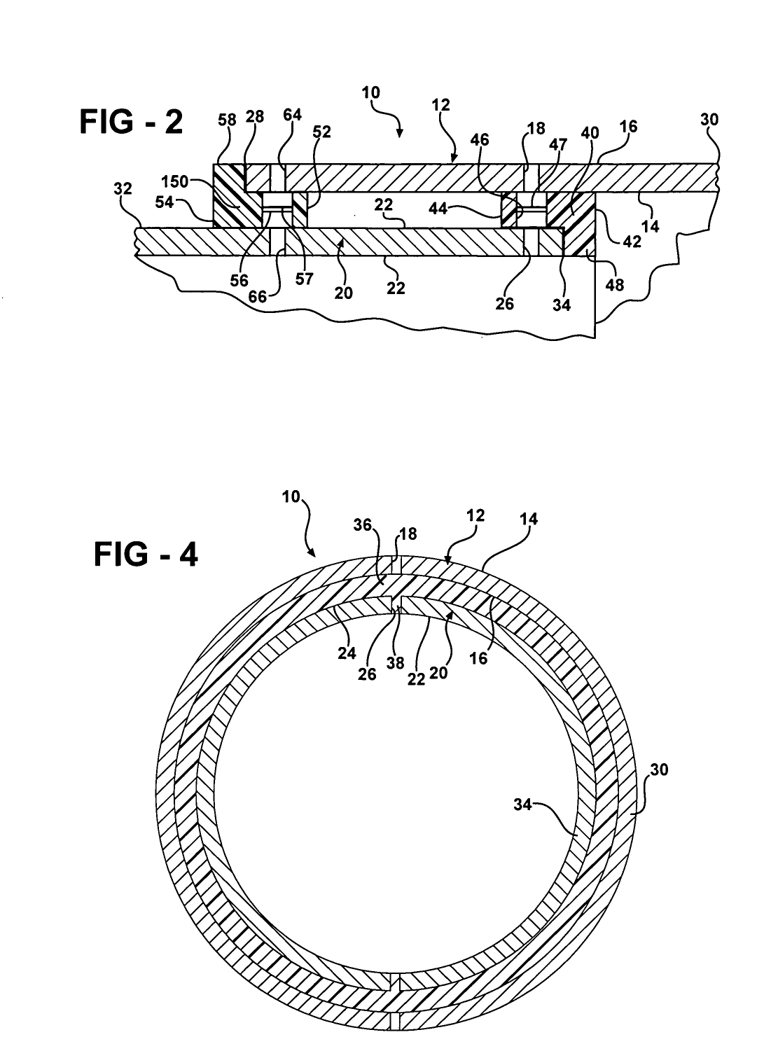

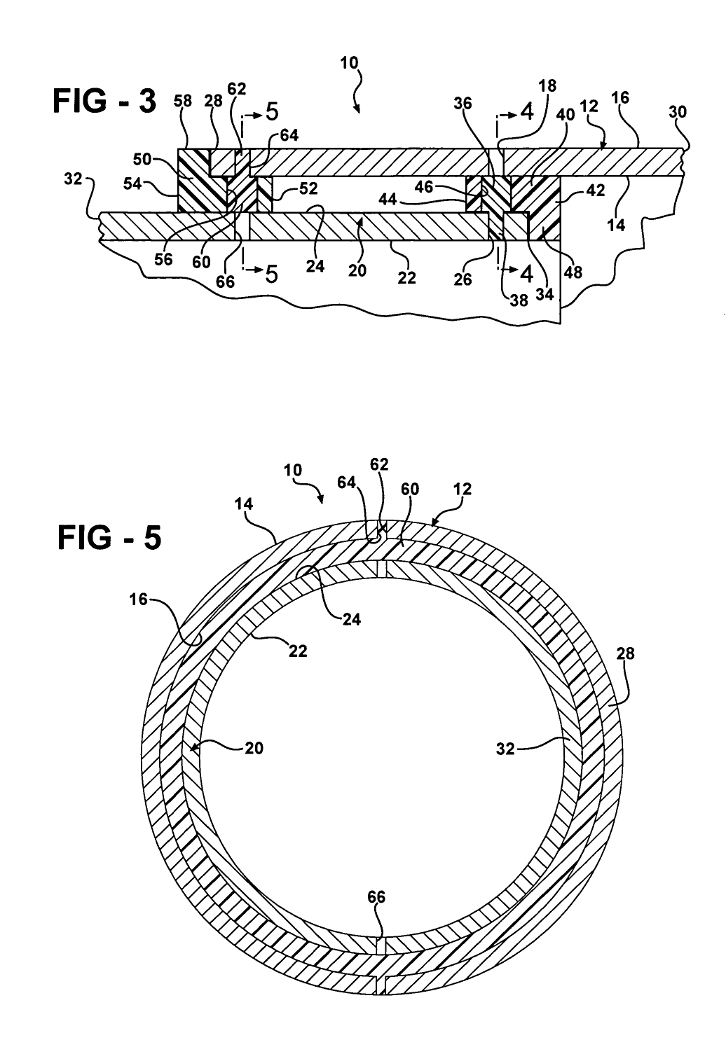

Referring to FIGS. 2 and 3, the telescoping steering column assembly 10 includes a sleeve 40 disposed annularly about the lower jacket 20 and within the upper jacket 12. The sleeve 40 includes terminal ends 42, 44 and an annular cavity 46 defined therewithin. The sleeve 40 includes a plurality of spokes 47 extending within the cavity 46 and interconnecting the terminal ends 42, 44. The spokes 47 are spaced one from the other annularly about the lower jacket 20 for the flow of the plastic material P throughout the annular cavity 46. The annular cavity 46 is open to the upper 12 and lower 20 jackets. The annular cavity 46 is designed to hold the bearing 36 therewithin having the projection 38 extending radially from the cavity 46. The sleeve 40 includes a lip 48 extending from one of the terminal ends 42 of the sleeve 40 to abut and engage the telescoping end 34 of the lower jacket 20. The bearing 36 is disposed in a sliding engagement over the hole 18 in the upper jacket 12 wherein the projection 38 extends into the hole 26 in the lower jacket 20.

Referring back to FIGS. 2 and 3, the telescoping steering column assembly 10 includes a second sleeve 50 disposed annularly about the lower jacket 20 and within the upper jacket 12. The second sleeve 50 is spaced from the first mention sleeve 40. Similar to the first mentions sleeve 40, the second sleeve 50 includes terminal ends 52, 54 and a second annular cavity 56 defined therewithin. The sleeve 50 includes a plurality of spokes 57 extending within the cavity 56 and interconnecting the terminal ends 52, 54. The spokes 57 are spaced one from the other annularly about the lower jacket 20 for the flow of the plastic material P throughout the annular cavity 56. The second annular cavity 56 of the second sleeve 50 is open to the upper 12 and lower 20 jackets. The second annular cavity 56 is designed to hold a second bearing 60 of plastic material spaced from the first mentioned bearing 36. The second sleeve 50 includes a lip 58 extending from one of the terminal ends 54 of the second sleeve 50 to abut and engage the telescoping end 28 of the upper jacket 12. The second bearing 60 includes a second projection 62 extending radially from the cavity 56 of the second sleeve 50 into a second hole 64 defined within the upper jacket 12. The second bearing 60 is disposed in a sliding engagement over a second hole 66 defined within the lower jacket 20 wherein the remaining second projection 62 extends into the second hole 64 in the upper jacket 12.

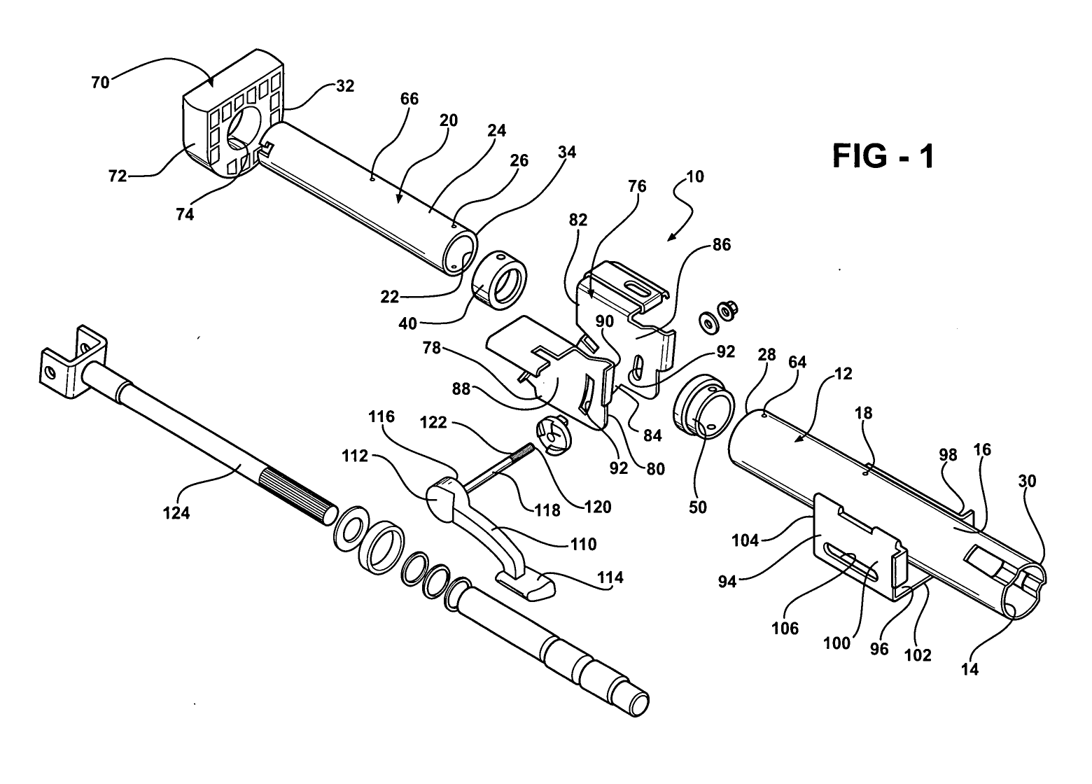

Referring back to FIG. 1, the telescoping steering column assembly 10 includes a lower mounting mechanism, generally indicated at 70, for connecting the lower jacket 20 to a vehicle body (not shown). The lower mounting mechanism 70 includes a lower bracket 72 of a generally rectangular configuration having an aperture 74 defined therewithin to engage one of the telescoping ends 34 of the lower jacket 20. The telescoping steering column assembly 10 also includes an upper mounting mechanism, generally indicated at 76, for connecting the upper jacket 12 to the vehicle body and to slidably support the upper jacket 12 for telescoping movement relative to the lower jacket 20 between various positions.

The upper mounting mechanism 76 includes an upper bracket 78 having first 80 and second 82 ends, a bottom 84, and sides 86, 88 extending upwardly from the bottom 84 to define a gap 90 therebetween. The upper bracket 78 includes a slot 92 defined within each of the sides 86, 88 at the first end 80.

The telescoping steering column assembly 10 includes a compression bracket 94 having a bottom 96 and side walls 98, 100 and first 102 and second 104 ends and an inlet 106 defined within the side walls 98, 100 and extending between the first 102 and second 104 ends of the compression bracket 94 perpendicularly to the slots 92 of the upper bracket 78. The compression bracket 94 is slidably disposed within the upper bracket 78. The telescoping steering column assembly 10 includes a release lever 110 having a shoulder 112 at one terminal end and a plate 114 at another terminal end. The shoulder 112 includes an inner surface 116 and a rod 118 extending outwardly therefrom to a distal end 120 having a male thread 122. In operation, the release lever 110, pushed upwardly or downwardly in different mode of operation controls the movement of the compression bracket 94 within the upper bracket 78. The telescoping steering column assembly 10 includes a shaft 124 extending linearly and transversely through the upper 12 and lower 20 jackets.

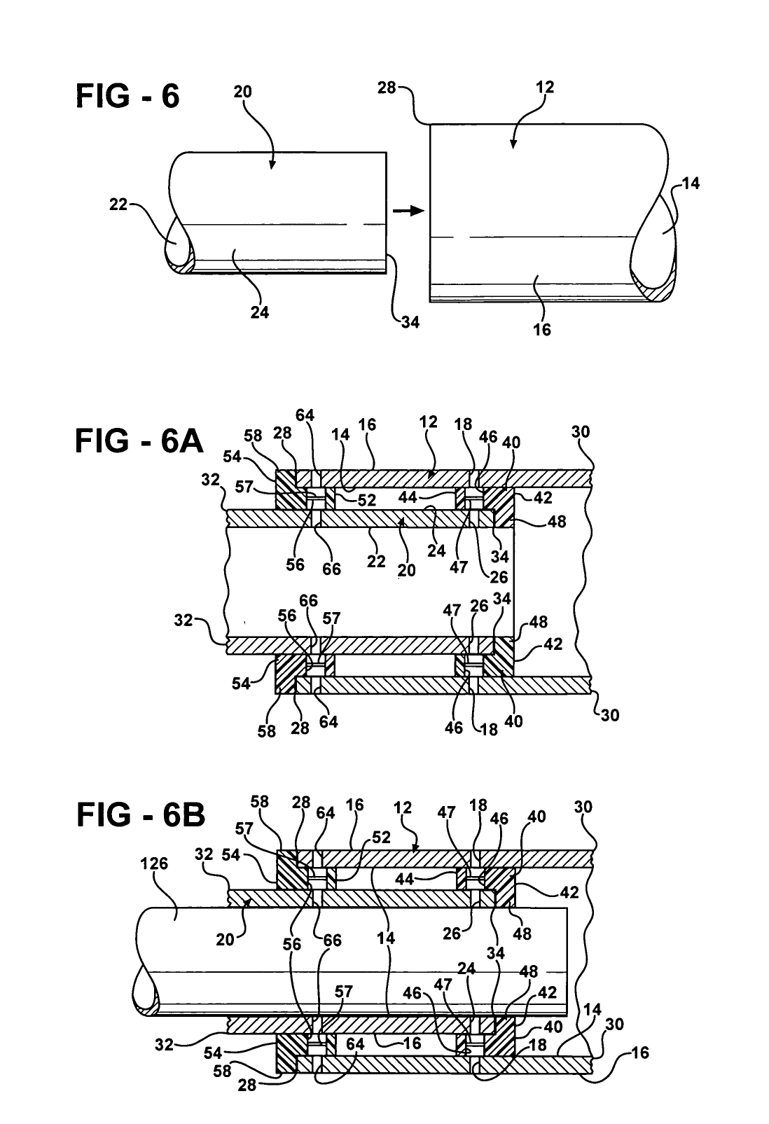

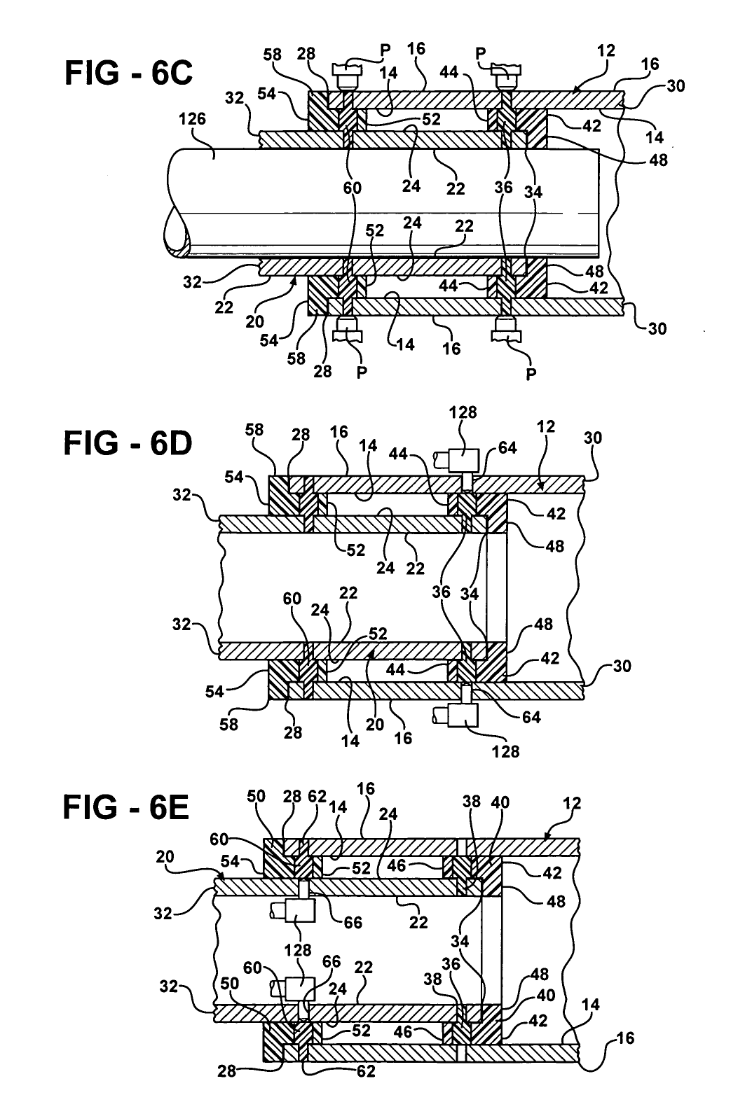

The present invention includes a method of making the telescoping steering column assembly 10 shown in FIGS. 6 through 11. The method begins with disposing the lower jacket 20 having at least one hole 26 extending between the inner 22 and the outer 24 surfaces and the telescoping ends 32, 34 in telescoping relationship within the upper jacket 12 having at least one hole 18 extending between the inner 14 and outer 16 surfaces and the telescoping ends 28, 30, as shown in FIGS. 6 and 7. As best shown in FIGS. 7 and 8, the next step of the method includes defining the cavity 46 extending annularly about the lower jacket 20 and within the upper jacket 12 by disposing the sleeve 40 having the terminal ends 42, 44 and the lip 48 extending from one of the terminal ends 42. The following step of the method includes defining the second cavity 56 extending annularly about the lower jacket 20 and within the upper jacket 12 by disposing the second sleeve 50 having the terminal ends 52, 54 and the lip 58 extending from one of the terminal ends 54 of the sleeve 50.

Referring back to FIG. 8, the method includes the step of blocking the inner surface 22 of the lower jacket 20 from the plastic material P by inserting a bar 126 into the lower jacket 20. The next step include injection of the plastic material P to form the bearing 36 disposed within the annular cavity 46 of the sleeve 40, wherein the bearing 36 is formed with the integral projection 38 extending radially from the annular cavity 46 to one of the holes 26 in the lower jacket 20, as shown in FIG. 9. The forming of the bearing 36 is followed by the step of injecting the plastic material P to form the second bearing 60 disposed within the annular cavity 56 of the second sleeve 50, wherein the second bearing 60 is formed with the second projection 62 extending radially from the annular cavity 56 to one of the holes 64 in the upper jacket, also shown in FIG. 9.

After the plastic material P has been injected, the method includes the step of removing the plastic material P from the hole 18 in the upper jacket 12 by a drill 128 to provide the sliding engagement of the bearing 36 over the hole 18 in the upper jacket 12 whereby the remaining projection 38 extends into the hole 26 in the lower jacket 20, as shown in FIG. 10. The method further includes the step of removing the plastic material P from the second hole 66 in the lower jacket 20 by the drill 128 to provide the sliding engagement of the second bearing 60 over the second hole 66 in the lower jacket 20 whereby the remaining second projection 62 extends into the second hole 64 defined within the upper jacket 12, as shown in FIG. 11.

Obviously, many modifications and variations of the present invention are possible in light of the above teachings. The invention may be practiced otherwise than as specifically described within the scope of the appended claims. These antecedent recitations should be interpreted to cover any combination in which the incentive novelty exercises its utility.

1. A telescoping steering column assembly (10) comprising;
an upper jacket (12) having inner (14) and outer (16) surfaces with a hole (18) extending between said surfaces (14,16) thereof;
a lower jacket (20) having inner (22) and outer (24) surfaces with a hole (26) extending between said surfaces (22,24) thereof;
said jackets (12,20) having telescoping ends (28,30,32,34) disposed in overlapping telescoping relationship with one another;
a bearing (36) of plastic material disposed annularly about said outer surface (24) of said lower jacket (20) and engaging said inner surface (14) of said upper jacket (12); and
said bearing (36) being in a sliding engagement over said hole (18) in one of said jackets (12) and including a projection (38) extending into said hole (26) in the other of said jackets (20).

2. A telescoping steering column assembly (10) as set forth in claim 1 including a sleeve (40) disposed annularly about said lower jacket (20) and within said upper jacket (12) and having terminal ends (42,44) and defining an annular cavity (46) extending about said lower jacket (20) and open to said jackets (12,20), said bearing (36) disposed in said cavity (46) and engaging said jackets (12,20).

3. A telescoping steering column assembly (10) as set forth in claim 2 wherein said sleeve (40) includes a lip (48) extending from one of said terminal ends (42) of said sleeve (40) and abutting said telescoping end (34) of one said jackets (20).

4. A telescoping steering column assembly (10) as set forth in claim 3 wherein said projection (38) extends radially from said cavity (46).

5. A telescoping steering column assembly (10) as set forth in claim 4 wherein said projection (38) extends into said hole (26) in said lower jacket (20).

6. A telescoping steering column assembly (10) as set forth in claim 3 wherein said lip (48) engages said telescoping end (36) of said lower jacket (20).

7. A telescoping steering column assembly (10) as set forth in claim 2 including
a second hole (64,66) in each of said jackets (12,20) and a second bearing (60) of plastic material spaced from said first mentioned bearing (36) and in sliding engagement over said second hole (66) in one of said jackets (20) and including a second projection (62) extending into said second hole (66) in the other of said jackets (12),
a second sleeve (50) disposed annularly about said lower jacket (20) and within said upper jacket (12) and having terminal ends (52,54) and defining an annular cavity (56) open to said jackets (12,20) in said cavity (56) of said second sleeve (50) and engaging said jackets (12,20).

8. A telescoping steering column assembly (10) as set forth in claim 7 wherein said first mentioned sleeve (40) includes a lip (48) abutting said telescoping end (34) of said lower jacket (20) and said second sleeve (50) includes a lip (58) abutting said telescoping end (28) of said upper jacket (12).

9. A telescoping steering column assembly (10) as set forth in claim 8 wherein said projection (38) of said first bearing (36) extends into said hole (26) in said lower jacket (20) and said projection (62) of said second bearing (60) extends into said second hole (66) in said upper jacket (12).

10. A method of making a telescoping steering column assembly (10) comprising the steps of:
disposing a lower jacket (20) having a hole (26) extending between inner (22) and outer (24) surfaces and a telescoping end (34) in telescoping relationship within an upper jacket (12) having a hole (18) extending between inner (14) and outer (16) surfaces and a telescoping end (30);
injecting a plastic material (P) between the upper (12) and lower (20) jackets and into the respective holes (18,26) in the jackets (12,20); and
removing the plastic material (P) from the hole (18) in only one of the jackets (12) while retaining the plastic material (P) in the hole (26) in the other jacket (20).

11. A method as set forth in claim 10 including defining a cavity (46) extending annularly about the lower jacket (20) and within said upper jacket (12).

12. A method as set forth in claim 11 wherein the step of defining the cavity (46) includes disposing a sleeve (40) having terminal ends (42,44) and defining the annular cavity (46) open to the jackets (12,20).

13. A method as set forth in claim 12 wherein the step of disposing the sleeve (40) is further defined as disposing the sleeve (40) having a lip (48) extending from one of the terminal ends (42) of the sleeve (40) and abutting the telescoping end (28) of one of the jackets (20).

14. A method as set forth in claim 10 including defining a second hole (64), (66) extending between the inner and outer surfaces of each of the jackets (12,20).

15. A method as set forth in claim 14 including defining a second cavity (56) extending annularly about the lower jacket (20) and within said upper jacket (12).

16. A method as set forth in claim 15 wherein the step of defining the second cavity (56) includes disposing a second sleeve (50) having terminal ends (52,54) and defining the annular cavity (56) open to the jackets (12,20).

17. A method as set forth in claim 16 wherein the step of disposing the second sleeve (50) is further defined as disposing the second sleeve (50) having a lip (58) extending from one of the terminal ends (54) of the second sleeve (50) and abutting the telescoping end (28) of the other of the jackets (20).

18. A method as set forth in claim 10 wherein the step of injecting the plastic material (P) is further defined as forming a bearing (36) disposed within the annular cavity (46) having a projection (38) extending into the hole (26) in the lower jacket (20) and a second bearing (60) disposed within the second annular cavity (56) having a projection (62) extending into the hole (64) in the upper jacket (12).

19. A method as set forth in claim 10 wherein the step of removing the plastic material (P) includes extracting the plastic material (P) from one of the holes (18) of the upper jacket (12) abutting the bearing (36) and one of the holes (66) of the lower jacket (20) abutting the second bearing (60).

20. A method as set forth in claim 19 including blocking the plastic material (P) injected between the upper (12) and lower (20) jackets from penetrating inside the lower jacket (20) by inserting a bar (126) therewithin.

21. A telescoping steering column assembly (10) comprising:
an upper jacket (12) of a generally tubular configuration having leading (28) and trailing (30) ends and inner (14) and outer (16) surfaces and at least one hole (18) extending therebetween;
a lower jacket (20) of a generally tubular configuration having leading (32) and trailing (34) ends and inner (22) and outer (24) surfaces and at least one hole (26) extending therebetween;
said lower jacket (20) being engaged within said upper jacket (12) in telescoping fashion;
a sleeve (40) disposed between said lower (12) and upper (20) jackets having terminal ends (42,44) and defining an annular cavity (46) open to said jackets (12,20);
said sleeve (40) having a lip (48) integral with and extending upwardly from one of said terminal ends (42) of said sleeve (40) to abut said telescoping end (34) of one of said jackets (20); and
a bearing (36) disposed in said annular cavity (46) having a projection (38) extending into said hole (26) in one of said jackets (20) and being in a sliding engagement over said hole (18) in the other of said jackets (12).
